(19) United States
(12) Patent Application Publication
(10) Pub. No.: US 2016/0297423 A1
(43) Pub. Date: Oct. 13, 2016

(54) METHOD AND DEVICE FOR CONTROLLING A HYBRID DRIVE IN A VEHICLE

(71) Applicant: Audi AG, 85045 Ingolstadt (DE)

(72) Inventors: Boris Blasinski, Gaimersheim (DE); YAOKUI XIONG, Ingolstadt (DE); PHILIPP SEYBERTH, Titting (DE)

(73) Assignee: Audi AG, 85045 Ingolstadt (DE)

(21) Appl. No.: 15/102,802

(22) PCT Filed: Dec. 1, 2014
(86) PCT No.: PCT/EP2014/003204

§ 371 Date: Jun. 8, 2016

(30) Foreign Application Priority Data
Dec. 9, 2013 (DE) 10 2013 020 759.2

(51) Int. Cl. B60W 20/13; G01C 21/34; B60W 20/12; B60W 10/06; B60W 10/08

(52) U.S. Cl. CPC B60W 20/13; B60W 10/06; B60W 10/08; B60W 20/12; G01C 21/3469

(57) ABSTRACT

In a method for controlling a hybrid drive in a vehicle a forward-looking prioritizing of the charging of the traction battery is superimposed over a charging strategy for controlling a charge state of the high-voltage traction battery, so that a load point shift is limited at the internal combustion engine to largely avoid unfavorable operating stats of the internal combustion engine.

The present invention relates to method and a device for controlling a hybrid drive in a vehicle.

In hybrid vehicles a battery is mostly charged during operation of an associated internal combustion engine, because there are only very few operating situations that allow a sufficient charging without additional fuel consumption, i.e., by recuperation or so-called regenerative braking in which an electric machine is operated as generator. Correspondingly the term charging strategy of a hybrid vehicle relates to a method, which controls a charge state of a traction battery by increasing the load on the internal combustion engine and operating the electric machine as generator. Typically the charging strategy has the goal to generate energy at a particularly good efficiency of all components of the hybrid drive.

From the state-of-the-art various methods and devices for implementing the above-mentioned approaches are known, which have the goal to reduce fuel consumption by using an appropriate control strategy that allows avoiding operation of the internal combustion engine in low efficiency ranges as far as possible or advantageously additionally activating the electric machine. Thus, the reference DE 10 2008 008 238 A1 discloses a method of a charging strategy of a hybrid drive and a control device executing this strategy, in which depending on various input variables a charging or discharging function is selected from a number of different such functions and is set at the internal combustion engine by a load point shift. Hereby also special operating states of the internal combustion engine are taken into account by using a characteristic field for correcting or limiting a load point shift desired for optimal charging of the battery with the goal to ensure a sufficient life time of the battery by limiting fluctuations of the charge state.

Besides saving fuel in a respective operating state and efficiency-optimized charging processes, the present invention also has the goal to increase the efficiency of such a method and a device for controlling a hybrid drive.

This object is solved according to the invention by the features of claim 1 in that a forward-looking prioritizing of the charging of the traction battery is superimposed over a charging strategy for controlling a charge state of the high-voltage traction battery, so that a load point shift is limited at the internal combustion engine to largely avoid unfavorable operating stats of the internal combustion engine. The term prioritizing hereby also means that a respective charging strategy is also changed in order to avoid operating states of the internal combustion engine in which the mixture in an Otto machine would be enriched and a soot limit in diesel machines would be exceeded. Thus according to the invention, knowing an actual work point of the internal combustion engine a load point shift is limited while maintaining favorable operating ranges and avoiding the above-mentioned exemplary unfavorable operating ranges.

In order to generate energy at a particularly favorable efficiency of all components of the hybrid drive, for example a so-called characteristic field of the internal combustion engine and a current-dependent internal resistance of the high-voltage traction battery can be taken into account. An important discovery is that charging the battery to an extent that is reduced compared to a maximal charging is also useful, whereby at the same time a shift of a load point or operating point of the internal combustion engine from a favorable range into an unfavorable range is avoided in a targeted manner. According to the invention a decreased charging of the battery is thus tolerated at least temporarily for avoiding excess fuel consumption. Overall this results in an improved overall efficiency of the hybrid drive.

The invention is also based on the recognition that under certain boundary conditions it may be useful to replace this rather static efficiency approach by a situation-dependent consumption optimization with forward-looking prioritizing of the charging of the traction battery. Thus for example when the driver desires a high performance of the internal combustion engine an additional load on the internal combustion engine due to the charging of the battery is temporarily or intermittently forgone in order to avoid unfavorable air fuel mixtures, for example enrichment of the mixture, when it is sufficiently likely that a comparatively more favorable situation for charging the battery will be encountered soon. This includes for example a charging of the battery by recuperation or regenerative braking in particular when a longer downhill slope follows an uphill incline.

Generally driving situations suitable for charging the traction battery are those in which an optimal internal combustion engine efficiency can be set. For example when driving with a constant speed of 50 km/h the charging power is obtained significantly more cost-effectively than during operation in neutral at standstill of the vehicle. However when the amount of electric energy stored in the traction battery declines the consumption-optimized charging strategy may have to be abandoned in favor of a so-called forced charging. In the forced charging a certain energy amount is introduced into the traction battery mostly without regard to an actual driving situation. This may thus significantly decrease the charging efficiency, which may lead to increased fuel consumption. For example avoiding unfavorable fuel-air mixtures may limit the charging strategy so that the traction battery is discharged to the point at which forced charging sets in. This means that in order to avoid a slight increase in consumption in a current state a significantly higher increase in consumption is accepted in a future state. This is because a forced charging has then to be performed regardless of how unfavorable this process may be in terms of efficiency of the hybrid drive.

This is were a method according to the invention comes to bear: by analyzing respectively actual future driving situations the method according to the invention plans a charging strategy in which it prioritizes consumption-optimal charging processes of the traction battery, which instead of focusing on a current optimal efficiency is geared towards an optimal overall efficiency of the drive over the distance to a respective destination. For a respective actual application, future driving situations encountered until reaching the destination are analyzed and used as basis to plan a charging strategy in which consumption-optimal charging processes of the traction battery are performed over a selected driving route until reaching a respective destination, A method according to the invention thus does not only focus on a respective actual operating state with a static efficiency analysis but also takes future operating states into account that will occur with a relatively high likelihood, wherein this likelihood is determined among other things based on known conditions encountered on a route to an actual destination. As a result consumption is no longer optimized for a respective time point but over a time period until reaching an actual destination or arriving at a destination in dependence on a selected route.

Advantageous refinements are set forth in the dependent claims. Correspondingly, according to an important refinement of the invention, future operating states are determined on the basis of a forward-looking analysis of a driving route. Navigation route data can thus be used to determine which route a driver will take with a certain likelihood. In a preferred embodiment of the invention the map data also provide information regarding attributes of the route sections, such as speed limits or the number of stops. The future route sections and/or their attributes are then analyzed over the drive time regarding load points to be expected at the internal combustion engine in each route section which provide a sufficient drive power and also allow a good charging efficiency.

In an embodiment of the invention such an analysis of a route section is updated at least once, for example by taking actual weather data, a reported traffic situation and/or actual reports regarding traffic impediments, for example encountered at construction sites, or temporary speed limits into account.

Defined route sections are preferably assigned to a predefined operating mode of the hybrid drive in a forward-looing manner. For example a play street is less suited for charging the traction battery because there the driver demands only low power and also only for a short period of time and thus driving exclusively with electric power is preferred. On the other hand an incline may require activation of the electric motor in addition to the propulsion provided by the internal combustion engine. On the other hand when driving along an extended downhill stretch, the internal combustion engine can be turned off and the speed can be regulated by operating the electric motor as generator, which at the same time causes charging of the traction battery.

In an advantageous embodiment of the invention beside predictive route data for the forward-looking prioritizing also values learned in the past are used, which for example depend on the consumption of a vehicle, the road on which the vehicle drives, or handling of the vehicle by the driver.

Overall a method has been described, which prioritizes electric driving over the charging of the traction battery by forward-looking planning and thus limits fuel consumption over an entire drive.

A device for controlling the hybrid drive or a control device in a vehicle in which the drive includes an internal combustion engine and an electric motor connected with a traction battery, clutches, a transmission and at least one wheel coupled with the transmission achieves the aforementioned object for implementing the aforementioned method in particular in that the control device includes a control unit for prioritizing the charging of the traction battery. The control unit is hereby connected with a first database in which a characteristic field of the internal combustion engine is stored and includes means which are configured for limiting the load point shift, using the exact knowledge of an actual operating point of the internal combustion engine, while maintaining favorable operating ranges of the internal combustion engine. A non exhaustive list of items that the control apparatus can be optionally connected to includes
a second database in which a characteristic field of a current-dependent internal resistance of the high-voltage traction battery is contained,
a navigation system which beside an exact information regarding an actual location also contains a respective destination of a drive and a selected route and/or
a receiver for receiving further factors that influence a planned operation of the hybrid drive, which factors usually are or reflect external or environmental or ambient influences.

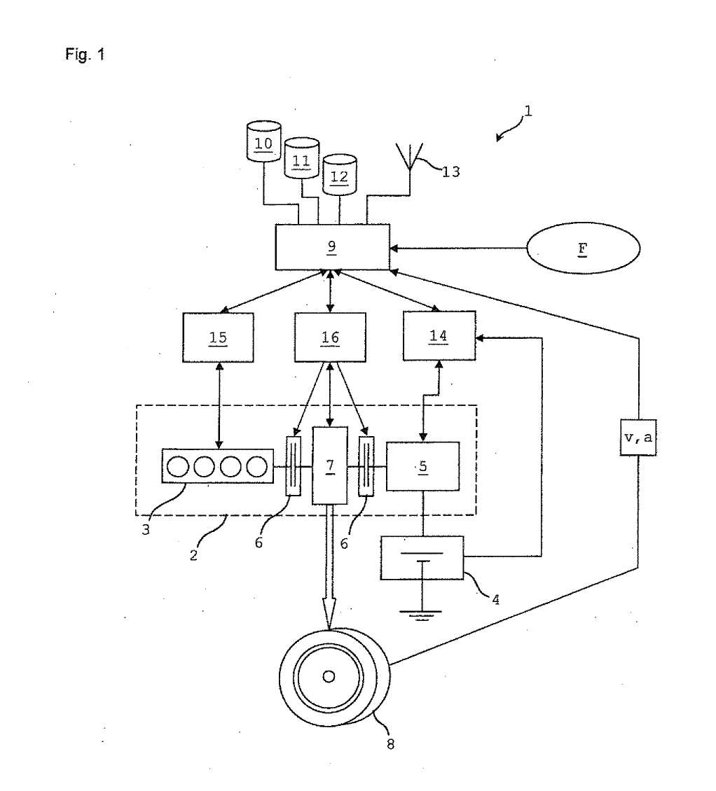

In the following further features and advantages of an embodiment according to the invention are explained in more detail by way of an exemplary embodiment with reference to the drawing. Herein FIG. 1 shows a schematic representation of a control device 1 for a drive 2 of a not further shown hybrid vehicle. The drive 2 includes a drive train including an internal combustion engine 3 and an electric motor 5 connected with a traction battery 4. Via clutches 6 the internal combustion engine 3 and/or the electric motor 5 are connected with the transmission 7. Via the transmission 7 a wheel 8 of the vehicle is then driven in a not further illustrated manner.

The control device 1 also includes a control unit 9 for charging the traction battery 4 according to a charging strategy. The term charging strategy of a hybrid vehicle refers to the control, which controls the charge state of the traction battery by increasing the load on the internal combustion engine 3 and using the electric motor 5 as generator. Typically the charging strategy has the goal to generate energy at a particularly good efficiency of all components of the hybrid drive 2.

In a not further illustrated basic form the control device 1 includes a control unit 9, which is connected with a first database 10 in which so-called characteristic curves or characteristic fields of the internal combustion engine 3 are stored. The control unit 9 also includes means which, based on the exact knowledge of the actual operating point of the internal combustion engine 3, are configured to limit a load point shift so that favorable operating ranges of the internal combustion engine are maintained, thus in particular avoiding a load point shift into unfavorable operating ranges. In other words: a desired charging of the traction battery 4 is ideally limited as additional load for the internal combustion engine 3 to the degree that the internal combustion engine 3 still operates in a favorable operating or work point. In the case of an Otto motor as the internal combustion engine 3 such unfavorable operating ranges are noted in the first database 10 as enrichment range, and in the case of a diesel engine as the internal combustion engine 3 such unfavorable operating ranges are noted in the first database 10 as a soot limit defined via a particle content in the exhaust gas. Such designations are known to the person with skill in the art in the form of marked sections in a characteristic field.

In the shown exemplary embodiment the control unit 1 is additionally configured for forward-looking prioritizing of the charging of the traction battery 4. In this example also a current-dependent internal resistance of the high-voltage traction battery is thus taken into account beside the characteristic field of the internal combustion engine 3. Because under certain boundary conditions it may be useful to replace a static efficiency approach by a situation-dependent consumption-optimized approach, the following describes fundamental additional features for implementing a method with forward-looking prioritizing of the charging of the traction battery 4. In such an approach, for example when the driver demands a high acceleration a or speed v, the additional load at the internal combustion engine 3 is intentionally forgone according to known approaches in order to avoid unfavorable air-fuel mixture ratios for example an enrichment, and to continue to operate the internal combustion engine 3 in ranges of the characteristic field that are favorable for consumption.

Generally driving situations that are appropriate for charging the traction battery are those in which an optimal internal combustion engine efficiency can be set. For example the power for charging can consistently be obtained at much lower cost when driving at 50 km/h than when driving in neutral at standstill. However when an energy amount stored in the high-voltage traction battery 4 declines the consumption-optimized charging strategy has to be abandoned and a so-called forced charging has to be performed. In the forced charging a certain amount of energy is introduced into the traction battery without regard to the driving situation.

In known systems the charging efficiency may thus be significantly impaired which may lead to increased fuel consumption. For example avoiding unfavorable fuel-air ratios may limit the charging strategy to the degree that the traction battery 4 is discharged to the point at which forced charging sets in. This means that in order to avoid a slightly increase in consumption in the actual state a significant increase in consumption is accepted in future states,

Current systems thus do not use a forward-looking planning of a charging strategy that provides for a prioritizing of the charging, By analyzing a respective future driving situation the charging strategy can perform a consumption-optimized prioritizing between the actual and the overall efficiency of the drive on the route until reaching the destination. In the present exemplary embodiment the control device 1 therefore also includes a control unit 9 for forward-looking prioritizing of the charging of the traction battery, which control unit is connected with a first database 10, in which a characteristic field of the internal combustion engine 2 is stored. The control unit 9 is also connected with a second database 11 in which a characteristic field of a current-dependent internal resistance of the high-voltage traction battery 4 is stored. The control unit 9 is also connected with a navigation system 12, which beside accurate information regarding an actual location also contains information regarding a respective destination of a drive and a selected route. Finally the control unit 9 is also connected with a receiver 13 for receiving further factors that also influence a planned operation of the hybrid drive. These factors include but are not limited to actual weather data, traffic interruptions, construction sites, temporary speed limits and/or other factors that influence traffic flow and with this a planned operation of the hybrid drive and respective information.

The control unit 9 has information regarding a respective driver request F and actual measuring values for an actual speed v and acceleration a at the wheel 8 of the vehicle the control unit 9 and accesses a controller 14 of the electric motor 5, a controller 15 of the internal combustion engine 3 and a controller 16 for the transmission 7 and the clutches 6, in the present example two clutches. The respective driver request F is hereby executed with maximum dynamic of the hybrid drive, wherein a respective access to the internal combustion engine 3 and/or the electric motor 5 occurs by taking certain boundary conditions into account. Accordingly the control unit 9 executes the driver request in the form of a situation-dependent and forward-looking planned consumption optimization, wherein further a charging of the high voltage traction battery 4 is the focus.

By analyzing respective actual driving situations the charging strategy performs a consumption-optimized prioritizing of charging processes of the traction battery 4, and in form of a route-dependent planning optimizes the overall efficiency of the drive on the route up to a respective destination.

In an embodiment information is obtained from the navigation system regarding the route a driver will drive on with a certain likelihood. The map data also provide information regarding certain attributes of the route driven on such as speed limits or a number of stop sites. The route sections ahead are then evaluated during the entire drive regarding expected load points at the internal combustion engine that permit a good charging efficiency.

Concrete examples for predefined route sections are:
1. a play street tends is rather less suited for charging the HV-battery because in this case due to the short and low power demands of the driver the electric drive is usually preferred.
2. a drive over a country road, in particular a highway, is usually characterized by average speeds in the range between 100 km/h and 150 km/h. In addition these speeds are kept constant. In this situation the internal combustion engine can be operated by selecting a high transmission ratio of the transmission in a very economical range, which in addition permits a load point shift by additionally charging the traction battery 4.

By predicting the energy required for electric driving in upcoming route sections and coordination with the energy actually available in the traction battery it can for example be decided whether or not limiting the charging due to enrichment will lead to forced charging at a later point in time. For example when a drive over the countryside, in which optimal charging is possible, follows the play street, the limitation can be activated without negative consequences.

The energy requirement is hereby calculated in correspondence with the predicted operating strategy in light of known future circumstances. Beside the predictive route data also values learned in the past can be used. For example in case of a plug-in hybrid it may be interesting to know where a client frequently uses a charging station. Storing the GPS position when charging at such a charging station allows generating a statistic so that when driving on typical routes toward a frequently used charging station it can be assumed that charging will be performed again. This makes it possible in these cases to prioritize electric driving over charging. Thus in this special case fuel consumption could be minimized again over an entire drive.

Energy for driving is thus generated at a particularly good efficiency for all components of the hybrid drive and in addition charging of the high-voltage battery 4 is given priority. The prioritizing uses predictions that originate from different sources and is hereby controlled so that a driver does not have to sacrifice comfort.

### LIST OF REFERENCE SIGNS

1 control device

2 drive

3 internal combustion engine

4 high-voltage traction battery

5 electric motor

6 clutch

7 transmission

8 driven wheel

9 device for prioritizing the charging of the traction battery 4

10 first database (characteristic field) with actual operating point and corresponding marking of favorable operating ranges of the internal combustion engine 3

11 second database (internal resistance of the traction battery)

12 navigation system

13 receiver of actual additional information

14 control of the electric motor 5

15 control of the internal combustion engine 3

16 control for transmission 7 and the clutch(es) 6

F driver request

a acceleration

v speed

1.-10. (canceled)

11. A method for controlling a hybrid drive in a motor vehicle, comprising:
charging a high-voltage traction battery with an electric motor during operation of an associated internal combustion engine according to a charging strategy for controlling a charge state of the high-voltage traction battery, said charging strategy providing for a prioritizing of the charging; and
limiting a load point shift at the internal combustion engine as a function of an actual operating point of the internal combustion engine so as to maintain operation of the internal combustion engine within favorable operating ranges.

12. The method of claim 11, wherein the prioritizing of the charging of the traction battery is a forward-looking prioritizing.

13. The method of claim 11, further comprising planning the charging by analyzing future driving situations to be encountered during a drive on a driving route until reaching a destination, said charging strategy comprising performing consumption-optimized charging processes of the traction battery while driving on the driving route until reaching the destination.

14. The method of claim 11, wherein the prioritizing of the charging of the traction battery is a forward-looking prioritizing and is a function of future operating states of the hybrid drive that will occur with a high likelihood.

15. The method of claim 14, wherein the likelihood is determined based on known conditions of a route for reaching an actual destination.

16. The method of claim 15, further comprising determining the future operating states and the likelihood based on analyzing at least one of an actual location of the motor vehicle, a destination, a selected driving route and an analysis of attributes of route sections of the selected driving route regarding the presence of load points at the internal combustion engine in the route sections, which beside provision of a sufficient drive power also enable a good charging efficiency.

17. The method of claim 11, further comprising updating the forward looking prioritizing by analyzing a driving route.

18. The method of claim 17, wherein the analyzing of the driving route comprises taking at least one of actual weather data, an actual reported traffic situation and actual reports regarding traffic impediments into account.

19. The method of claim 18, wherein the traffic impediments comprise construction sites or temporary speed limits.

20. The method of claim 18, wherein the updating is performed when determining a driving route.

21. The method of claim 11, further comprising assigning defined route sections to a predefined operating mode of the hybrid drive in a forward-looking manner.

22. The method of claim 12, wherein predictive route data and prior learned values are used for the forward-looking prioritizing, said prior learned values being dependent on at least one of a consumption of the motor vehicle, a region driven on and handling of the motor vehicle by a driver.

23. A device for controlling a hybrid drive in a vehicle, said hybrid drive comprising:
an internal combustion engine;
an electric motor connected with a traction battery;
clutches, a transmission and at least one driven wheel coupled with the transmission; and
a control device configured for implementing the method of claim 11, said control device comprising a control unit for prioritizing the charging of the traction battery, and being connected with a first database in which a characteristic field of the internal combustion engine is stored, said control unit comprising means configured for limiting a load point shift of the internal combustion engine as a function of an actual operating point of the internal combustion engine, while maintaining favorable operating ranges.
